(19) United States
(12) Patent Application Publication
(10) Pub. No.: US 2018/0268089 A1
(43) Pub. Date: Sep. 20, 2018

(54) Ellipsoid Cell Modeling

(71) Applicants: Simon Kahan, Seattle, WA (US); Seunghwa Kang, Seattle, WA (US)

(72) Inventors: Simon Kahan, Seattle, WA (US); Seunghwa Kang, Seattle, WA (US)

(21) Appl. No.: 15/406,761

(22) Filed: Jan. 15, 2017

(51) Int. Cl. G06F 17/50

(52) U.S. Cl. CPC G06F 17/5009

(57) ABSTRACT

An ellipsoid cell model for modeling cell and tissue organisms may enhance the quality of simulation of complex biological systems. Ellipsoid cell model may relate to the use of ellipsoid shapes to represent cells for modeling a biological system. This method may be capable of providing a more realistic representation of cells, for conducting computational experiments to study biological complexities at a large scale.

### FIELD

This disclosure relates generally to the field of an ellipsoid cell model.

### BACKGROUND

Various computational models may be used for the detailed study of biological systems. These models may be valuable to researchers as they allow researchers to predict the functioning of biological systems under tested circumstances. Computational models may allow researchers to conduct computational experiments to study biological complexities. Computational models generally represent cells as spheres, cubes, or cylinders.

### SUMMARY

The following presents a simplified summary of the disclosure to provide a basic understanding to the reader. This summary is not an extensive overview of the disclosure, nor does it identify key or critical elements of the claimed subject matter, or define its scope. Its sole purpose is to present some concepts disclosed in a simplified form as a precursor to the more detailed description that is later presented.

The instant application discloses, among other things, an ellipsoid cell model, which may enable a user to undertake high performance and highly scalable modeling and simulation of biological phenomena, such as microbial community, cell colony or tissue behavior over time. An ellipsoid cell model may be capable of improving the fidelity of visual representations detailing cell growth, division, and death. A user may use an ellipsoid cell model to view, test, and study biological properties of cells, tissues, and whole organisms. The ellipsoid cell model may improve a user's work analyzing biological functions, and may increase the fidelity of the model by more accurately representing the physical extent of a majority of modeled cells. Multiple ellipsoids may also be used as building blocks to form non-convex representations of cells such as dendrites, diatoms, and melanocytes.

For example, in the epidermis, skin cells are generated by skin stem cells near a basement membrane. These cells are pushed up as new cells are generated. As cells get nearer to the surface of the skin, they may undergo cornification and may flatten, dehydrate, and eventually get pushed and abraded away, and fall off.

An ellipsoid cell model may allow these cells to be represented as ellipsoids matching the change in shape cells experience over time. In the model, cells may start as spherical, and then change over time into more elongated ellipsoids. This may more closely match the actual physical transformation than other models do, and thereby enable researchers to extract more meaningful information and have more predictive power in their experimental analysis.

An ellipsoid cell model may be capable of testing hypotheses and by allowing computational experiments to study biological complexities with higher fidelity at a larger scale than conventional computational modeling systems. An ellipsoid cell model may provide an optimal solution to a tradeoff of representing cells generally and offering computational efficiency. During the development of new medical or cosmetic treatments, various tests may be required to determine the effect of treatment or device on living cells and tissues. Various algorithms may be used to implement an ellipsoid cell model.

One example of an ellipsoid cell model is a cell-level computational model for simulating behavior of skin cell generation, division, and destruction. This ellipsoid cell model may allow for simulating both steady-state (homeostatic) and transient behavior of skin cell regeneration and destruction. This embodiment may enable researchers to more realistically analyze the skin-cell development of persons in general or specifically because ellipsoids may be better suited to represent skin cells than spheres, cubes or cylinders.

Many of the attendant features may be more readily appreciated as they become better understood by reference to the following detailed description considered in connection with the attached drawings.

### BRIEF DESCRIPTION OF THE DRAWINGS

FIG. 1 illustrates an ellipsoid cell model of skin cells, according to one embodiment.

FIG. 2 illustrates changes in cells over time, according to one embodiment.

FIG. 3 illustrates a side view of a skin cell in an ellipsoid cell model, according to one embodiment.

FIG. 4 illustrates a top view of a skin cell in an ellipsoid cell model, according to one embodiment.

FIG. 5 illustrates two cells in contact in an ellipsoid cell model, according to one embodiment.

FIG. 6 illustrates two cells in contact forming a junction in an ellipsoid cell model, according to one embodiment.

FIG. 7 is a flow chart of an ellipsoid cell model process, according to one embodiment.

FIG. 8 is a component diagram of a computing device which may support an ellipsoid cell model, according to one embodiment.

### DETAILED DESCRIPTION

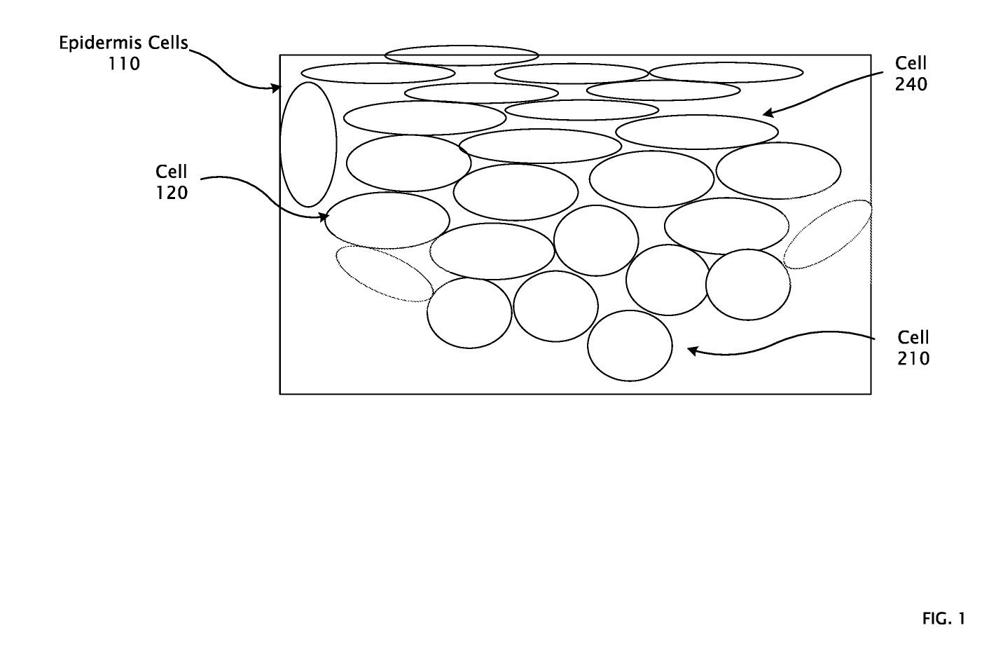

FIG. 1 illustrates an ellipsoid cell model of skin cells, according to one embodiment.

An Ellipsoid Cell Model may be a cell-level computational model for simulating behavior of a Skin Cell 120 generation, division, and destruction. Cell 120 may represent an actual or synthetic cell, a group of cells, or a portion of a cell. It may be appropriate to represent Skin Cell 120 using an ellipsoid because as Cell 120 grow towards the surface, it may begin to flatten and dry out. As it rises from the bottom layers to the surface, it may grow thinner. An Ellipsoid Cell Model may approximate this natural process more accurately than spherical, cubical or cylindrical models. An Ellipsoid Cell Model may allow for simulating steady-state and transient behavior of Skin Cell 120 regeneration and destruction, which may enable researchers to more realistically analyze skin cell development.

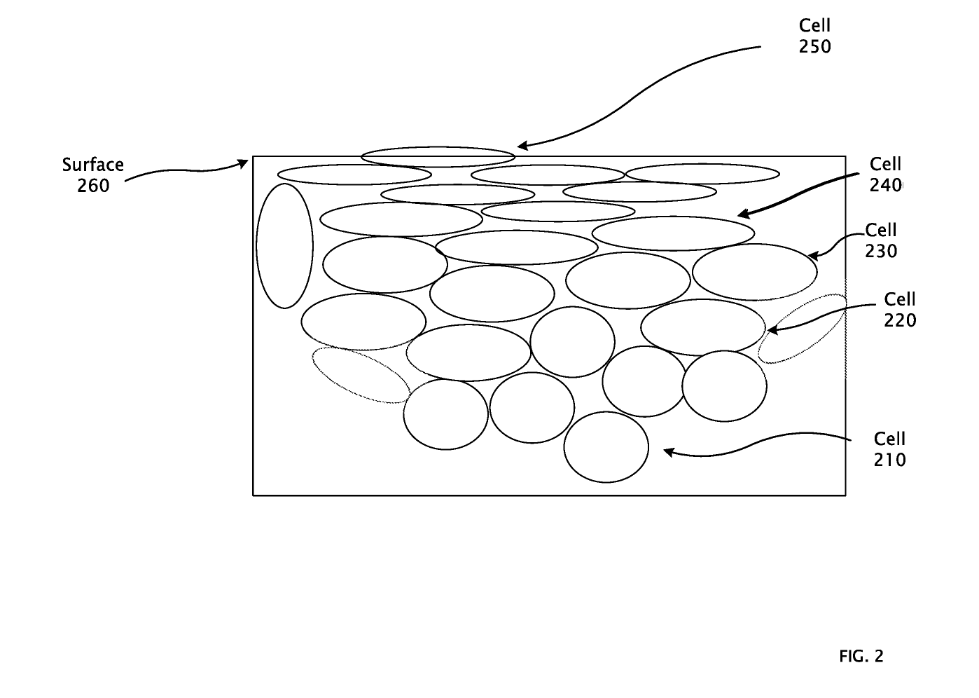

FIG. 2 illustrates changes in cells over time. Cell 210 may be newly generated by skin stem cells, for example. Cell 210 may initially be represented by a sphere, spheroid, or ellipsoid, for example. Cells may be differentiated over time. As a cell gets jostled, for example by new cells generated below it, it may adopt a larger aspect ratio, as may be seen in Cell 220. As growth continues, cells may be pushed, jostled, and squeezed more by other cells, becoming more eccentric in aspect ratio, as illustrated with Cell 230. As cells get closer to Surface 260, they may begin to dry out, becoming thinner and more eccentric, as in Cell 240. As they reach the surface, they may be fall or become abraded and break loose from the skin, as Cell 250 illustrates.

One having skill in the art will recognize that ellipsoids in an ellipsoid cell model may have any orientation relative to one another. Ellipsoids also may not be constrained to spheroid shapes; their two-dimensional representation in FIG. 2 as ellipses is for the purpose of illustration.

Distances between cells may be calculated as a distance between a closest pair of points with one point on each ellipsoid.

Cell 250 may break free of Surface 260 based on a set probability. The probability may increase as junction strength between Cell 250 and other cells decreases. Cell 250 may also detach if all junctions break. Late stage corneocytes may be set not to form new junctions.

An Ellipsoid Cell Model may support modeling transport to represent molecules, such as water, calcium ions, or lipid molecules, for example, moving into and out of cells.

One having skill in the art will recognize that various methods of modeling transport, such as diffusion or advection, may be implemented.

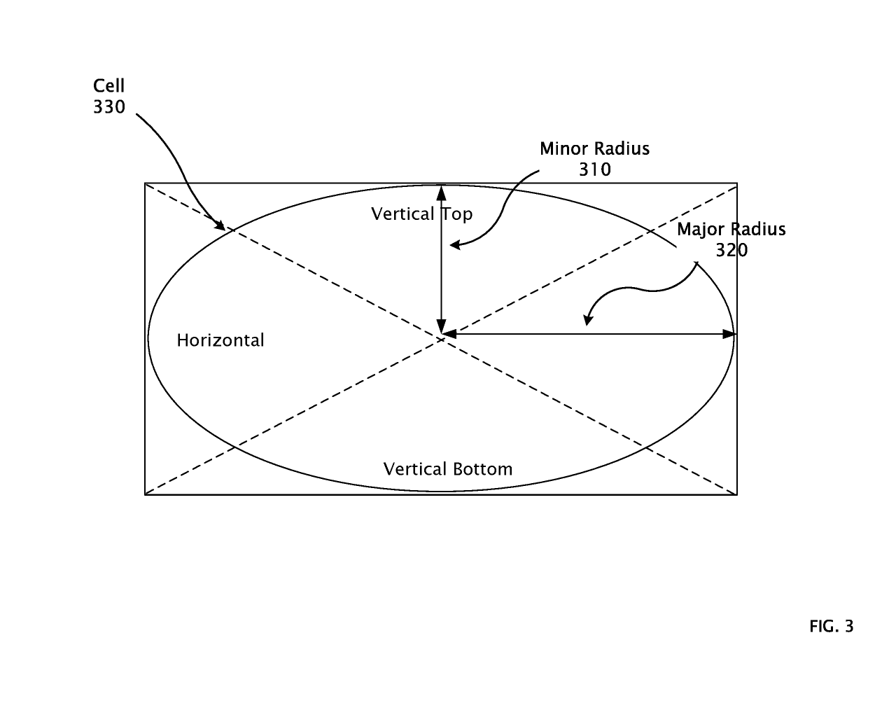

FIG. 3 illustrates a side view of skin Cell 330 in an ellipsoid cell model, according to one embodiment. Cell 330 represents a skin cell as an ellipsoid with a Minor Radius 310 and a Major Radius 320. Keratinocytes and corneocytes may be represented as spheroids, with a Minor Radius 310 measuring one-half the length of Major Radius 320. Other types of cells may be represented as spheres.

Cell growth may be modeled by having horizontally dividing cells grown horizontally, increasing Major Radius 320, while vertically dividing cells may grow vertically, increasing Minor Radius 310. Growth may continue until a target aspect ratio is attained, at which time cell division may be modeled. One having skill in the art will recognize that cells may divide in any direction.

For cell division, basement membrane agents may be bipartitioned. Mother and daughter cells may be rotated to align with the basement membrane agents.

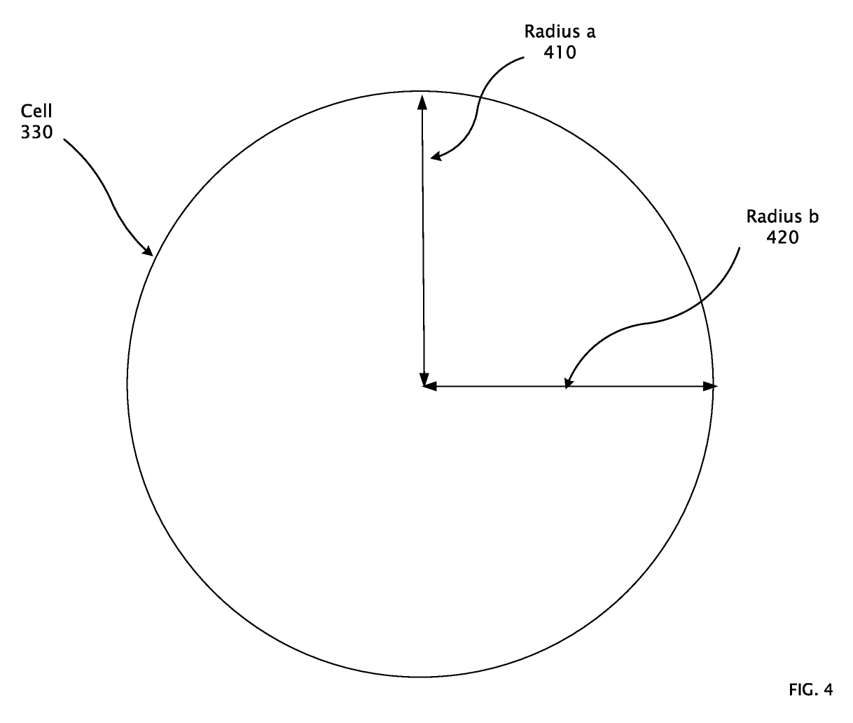

FIG. 4 illustrates a top view of skin Cell 330 in an ellipsoid cell model, according to one embodiment. Radius a 410 may be equal in length at Radius b 420, for all types of skin cells.

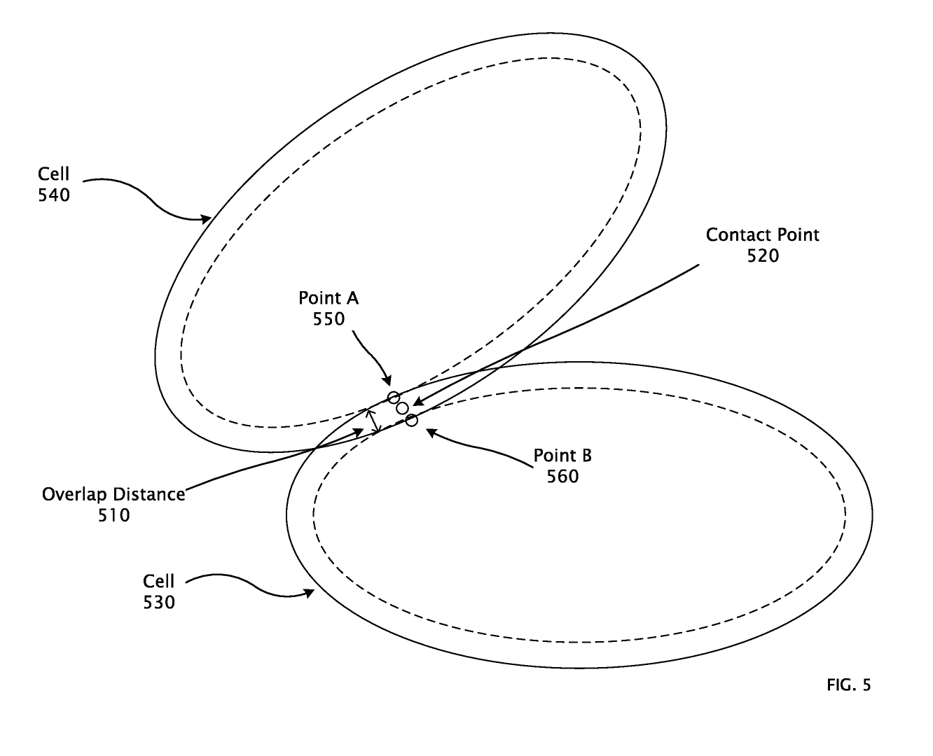

FIG. 5 illustrates two cells in contact in an ellipsoid cell model, according to one embodiment. Cell 530 and Cell 540 may contact each other at Contact Point 520. Overlap Distance 510 may depend on interior pressure within each of Cell 530 and Cell 540, and on a force with which they collide.

Cell 530 may shove Cell 540 with force proportional to Overlap Distance 510, in a direction aligned with Point A 550 and Point B 560.

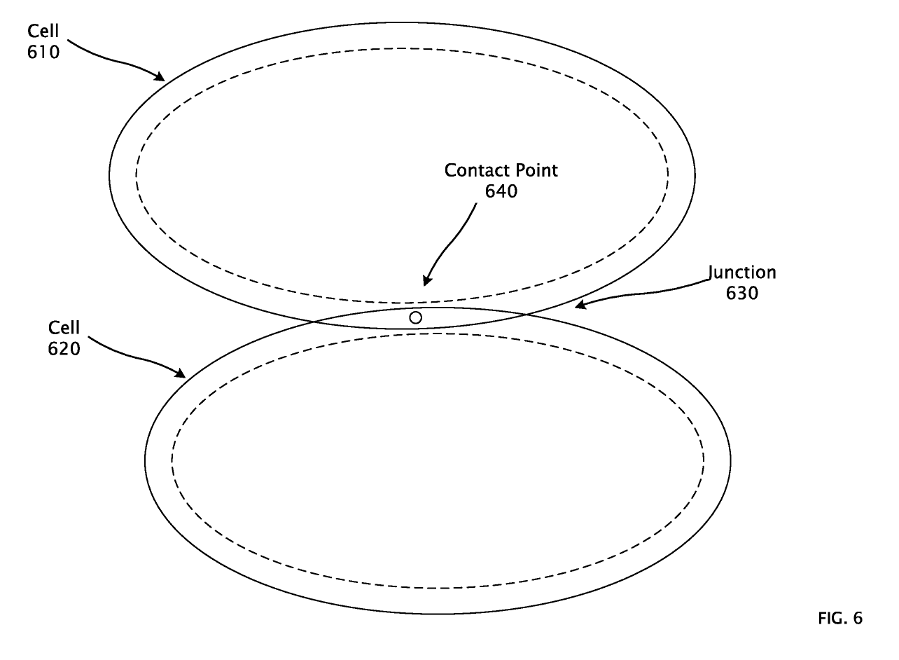

FIG. 6 illustrates two cells in contact forming a junction in an ellipsoid cell model, according to one embodiment. Cell 610 may be a keratinocyte or corneocyte, while Cell 620 may be a keratinocyte, corneocytes, or a basement membrane cell. If Cell 610 is a basement membrane cell, a junction will only form if Contact Point 640 is at a vertical bottom of Cell 610. Junction force may be determined by the types of cells involved, while adhesion may be calculated by the junction force and the area of contact between the cells.

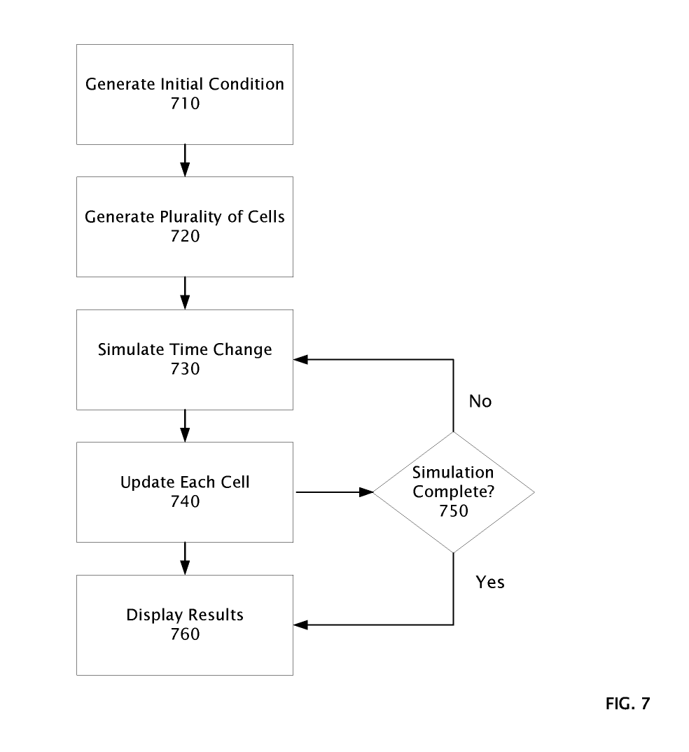

FIG. 7 is a flow chart of an ellipsoid cell model process, according to one embodiment.

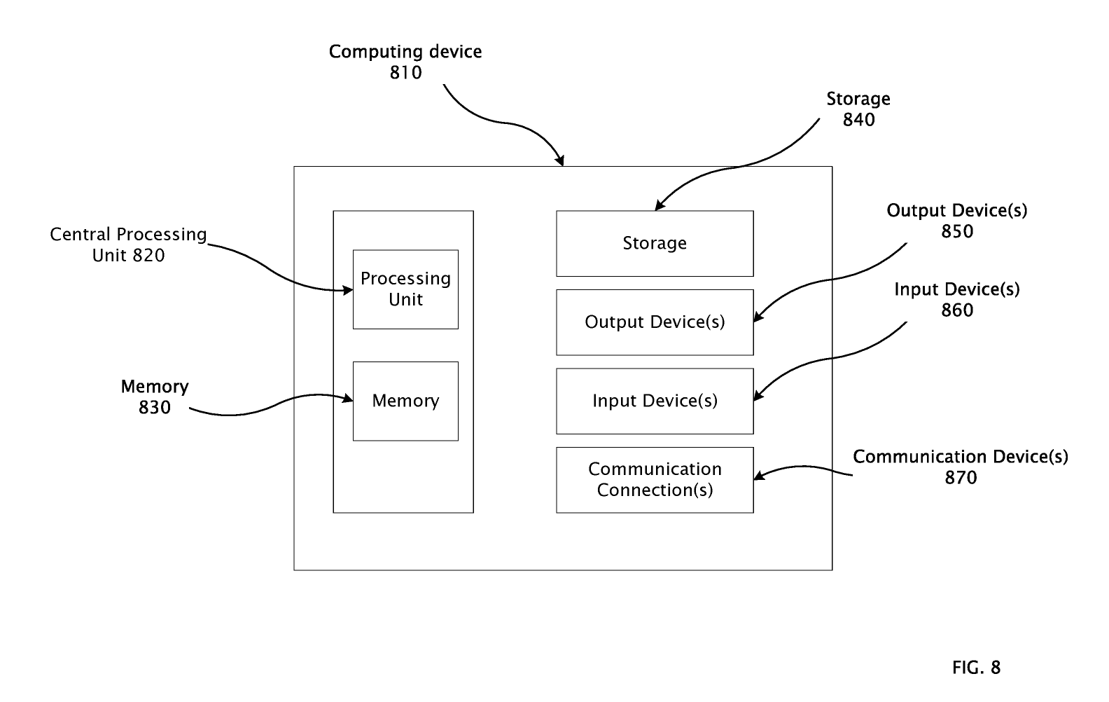

FIG. 8 is a component diagram of a computing device which may support an ellipsoid cell model, according to one embodiment. Computing Device 810 can be utilized to implement one or more computing devices, computer processes, or software modules described herein, including, for example, but not limited to a mobile device. In one example, Computing Device 810 can be used to process calculations, execute instructions, and receive and transmit digital signals. In another example, Computing Device 810 can be utilized to process calculations, execute instructions, receive and transmit digital signals, receive and transmit search queries and hypertext, and compile computer code suitable for a mobile device. Computing Device 810 can be any general or special purpose computer now known or to become known capable of performing the steps or performing the functions described herein, either in software, hardware, firmware, or a combination thereof.

In its most basic configuration, Computing Device 810 typically includes at least one Central Processing Unit (CPU) 820 and Memory 830.

Depending on the exact configuration and type of Computing Device 810, Memory 830 may be volatile (such as RAM), non-volatile (such as ROM, flash memory, etc.) or some combination of the two. Additionally, Computing Device 810 may also have additional features/functionality. For example, Computing Device 810 may include multiple CPU's. The described methods may be executed in any manner by any processing unit in Computing Device 810. For example, the described process may be executed by both multiple CPUs in parallel.

Computing Device 810 may also include additional storage (removable or non-removable) including, but not limited to, magnetic or optical disks or tape. Such additional storage is illustrated by Storage 840. Computer readable storage media includes volatile and nonvolatile, removable and non-removable media implemented in any method or technology for storage of information such as computer-readable instructions, data structures, program modules or other data. Memory 830 and Storage 840 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 810. Any such computer readable storage media may be part of Computing Device 810. But computer readable storage media does not include transient signals.

Computing Device 810 may also contain Communications Device(s) 870 that allow the device to communicate with other devices. Communications Device(s) 870 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device 810 may also have Input Device(s) 860 such as keyboard, mouse, pen, voice input device, touch input device, etc. Output Device(s) 850 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

1. A method of modeling living tissue over time, comprising:
generating an initial condition for a model;
generating a plurality of cells;
simulating a plurality of time changes, for each time change:
for each cell, determining which cells will collide and thereby cause a change in location or shape of the cell;
determining an amount of growth for the cell, the amount of growth giving a new size for the cell; and
updating the model with determined location, shape, and size of the cell.

2. The method of claim 1, wherein the change in location or shape of the cell is calculated using factors including elasticity of the cell, elasticity of colliding cells, a speed the with which colliding occurs.
